(19) United States
(12) Patent Application Publication
(10) Pub. No.: US 2018/0292224 A1
(43) Pub. Date: Oct. 11, 2018

(54) System and method for traffic volume estimation

(71) Applicant: Gregory Brodski, Warwcik, MA (US)

(72) Inventors: Gregory Brodski, Warwick, MA (US); Andrey Berkovsky, Saint -Petersburg (RU); Mikhail Bakhtin, Saint-Petersburg (RU)

(21) Appl. No.: 15/479,330

(22) Filed: Apr. 5, 2017

(51) Int. Cl. G01C 21/34; G08G 1/01

(52) U.S. Cl. CPC G01C 21/3492; G08G 1/0145; G08G 1/0129

(57) ABSTRACT

An automated system and integrated method for traffic volume estimation that collects GPS data from available sources, furnished with the novel algorithm which uses and analyzes the information on road patterns and traffic signal timing along with the accumulated GPS data, and estimates the value of traffic volume for a road section which may consist of one or more segments on a basis of the values of travel times and probes collected from GPS sources available for each road segment, with the use of the saturation flow value, defined with the consideration of road geometry, traffic signal timing, and registered traffic events of traffic volumes for each timing interval for each section of the road in a road network.

### BACKGROUND OF THE INVENTION

This invention relates to a method and system for traffic volume estimation that uses GPS probes in order to establish hardware-free traffic survey of sufficient quality for the purposes of traffic control, traffic modeling, transportation planning, business sites analysis and more.

Note. All terms are used according to the book: N. J. Garber, L. A. Noel. Traffic and Highway Engineering. Second edition, PWS Publishing Co, NY, 1110 p.

Currently, hardware-based traffic survey methods are based on: permanent detection, portable detection, traffic counting and floating vehicles [1, 2]. These methods ensure traffic volume estimation with median relative error (MRE) between 5% and 20% [10, 11]. There are three main challenges facing this approach: (1) high cost of equipment, its installation and maintenance; (2) limited reliability of hardware, which leads to uncertainty in the results (according to Caltrans about 30% of traffic detectors in the San Francisco Bay Area provide erroneous data and a knowledge of which 30% are wrong is limited); (3) limited coverage of road network—less than 10% in the U.S. and less than 5% worldwide.

Hardware-free traffic survey solutions are based on GPS-tracking [3, 4, and 5]. There are several independent GPS providers which collect travel time information from so-called ‘connected cars’, i.e. commercial fleet vehicles, navigation users, cell phones users, etc., and sell this information on the open market in raw or processed form. Sometimes, in addition to travel time information, GPS probe data, i.e. the number of vehicles observed over a fixed period of time, maybe also available. There are three types of approaches to the use of GPS information for traffic flow volume estimation:
The first approach is based on flow speed measurement through GPS—travel time data collection [3, 4]. This information, however, can be used only for the purpose of travel time forecast or LOS (level of service) evaluation [8].
The second one is based on numbers of GPS-observed vehicles measurement (GPS probes). This approach uses an assumption that the number of individual probe points observed on a given segment of road over a fixed period of time is proportional to the average traffic density on that segment of road [5]. According to our findings, this assumption is not always true (FIG. 1), which is also supported by experiments shown in thesis [7]. Therefore, this approach leads to unacceptable inaccuracy, to need for of calibration and, eventually, to limited practical use.
The third one is based on the use of GPS travel time measurements of different kinds and fundamental traffic diagram [5, 6, and 9]. Due to high variability of roads capacity levels, the accuracy of traffic flow estimation with the currently available techniques is insufficient. MRE even for average daily traffic volume estimation varies from 35% to 60%, depending on the street type. Practical utilization of these techniques requires individual calibration with the use of detector data, which makes their industrial implementation impractical.
The fourth approach is based on the use of mixed measurements, including sensor-based and GPS-based [12], also known as ‘data fusion’. This approach amplifies traffic flow information but same time has similar problems as the first one, due to extensive hardware utilization

All known hardware-free approaches consider only the information about travel time and number of the vehicles. Due to relatively small percentage of the vehicles, which are willing and able to transmit their location (GPS) information to the provider, the accuracy of traffic flow estimation based on these approaches is limited and unsatisfactory for the most of industrial tasks.

The goal of this invention is to develop an automated system and integrated method for accurate traffic flow volume estimation based on combined utilization of all available knowledge, including not only GPS travel time data and GPS probe data, but also geo information about road network, fundamental traffic diagram and parameters of traffic lights.

### BRIEF SUMMARY OF THE INVENTION

The present invention provides an automated system and an integrated method of traffic volume estimation. The estimation may apply to one segment, several independent segments, as well as to one or more sections of the road.

The innovative automated system includes the components for roads data collection, traffic signal description, GPS travel time and GPS probe data gathering, and analytical/computation unit.

The system obtains information on each segment of road network and each signal-equipped intersection, organizes the segments into road sections, and calculates the road capacities based on fundamental diagram with the use of speed limit parameter. Further calibration of ‘traffic flow speed’-‘traffic flow density’ curve (TFS/TFD curve) is based on free flow behavioral analysis with the consideration of GPS collected data on travel time distribution. Based on calibrated TFS/TFD curve and measured values of median vehicle travel time, the calculation unit provides traffic flow estimation for each timing interval. GPS probe data is used as an indicator of the degree of road congestion in cases of under-saturated conditions. The array of estimated traffic volume values, along with median and maximal values of traffic flow speed for each segment/section of the road for each timing interval provides full description of traffic flow patterns for the road network.

### BRIEF DESCRIPTION OF DRAWINGS

FIG. 1. Statistical relationship between GPS probes and traffic volume.

This Figure based on field test data, shows poor correlation between the number of individual probe points observed on a given segment of road over a fixed period of time and real traffic flow on that segment of road, measured by conventional traffic detector.

FIG. 2. Operating scheme for the invention.

This Figure is a block diagram, showing functional components of the invention.

FIG. 3. Controlled route described according to present invention.

This Figure illustrates the example of controlled route description. Controlled route consists of two sections between Intersections 1 and Intersection 2. Section 1 represents westbound movement. This section comprises of 4 segments (from Segment 1 to Segment 4), assigned by 3-rd party GPS provider. Analogically, Section 2 (eastbound direction) consists of 5 segments (from Segment 5 to Segment 9).

FIG. 4. Traffic flow volume estimation.

This Figure is a real-time software screen short, which shows traffic flow volume graph as well as other traffic flow parameters for control route, estimated by presently invented system and method.

FIG. 5. Accuracy of present invention in comparison with hardware-based technology.

The Figure is a chart, which compares traffic flow volume value estimated by presently invented system and method with state of the art video detection system and manual verification.

FIG. 6. Accuracy of present invention in comparison with presently known GPS technology.

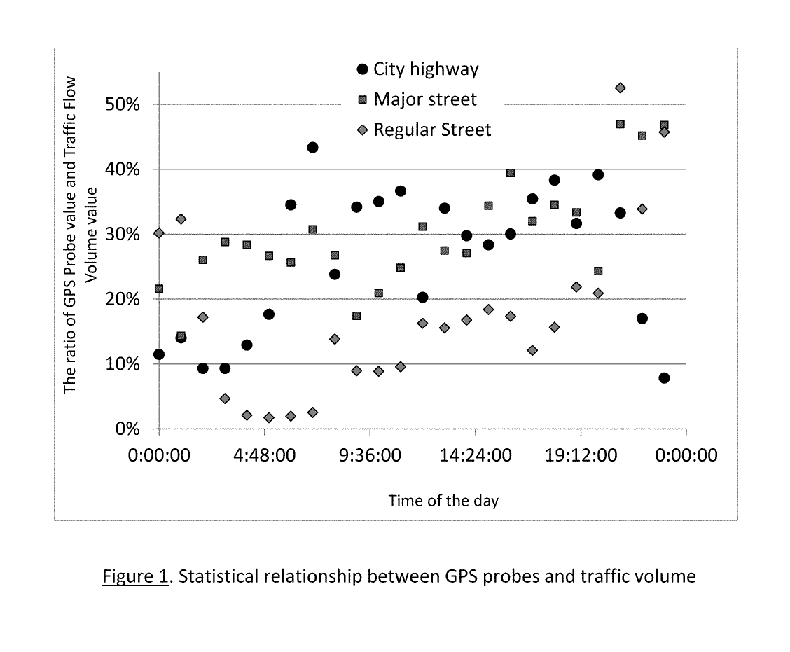

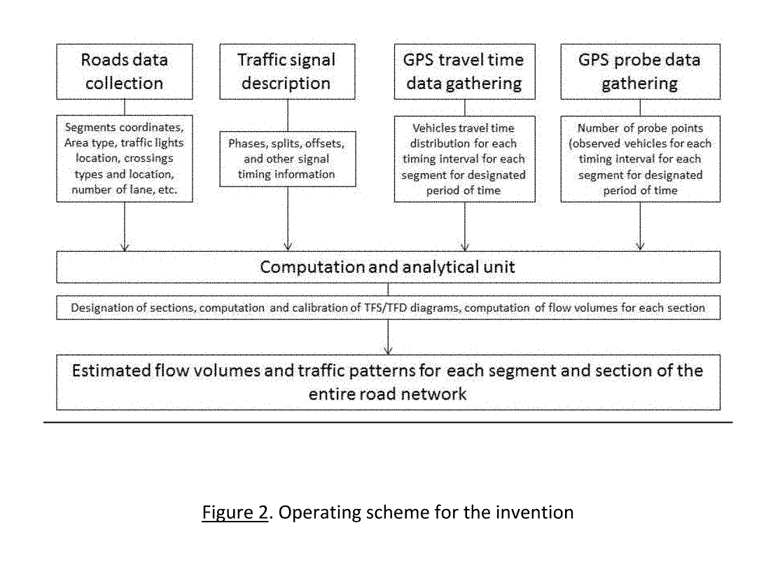

The chart compares median relative errors achieved by presently invented system and method in comparison with other types of GPS-based technology [6].

### DETAILED DESCRIPTION OF THE INVENTION

The present invention provides an automated system and an integrated method for traffic volume estimation. The estimation may apply to one segment, several independent segments, or a section of a road.

The system obtains information on each segment of road network and each signal-equipped intersection, organizes the segments into road sections and calculates the road capacities based on fundamental diagram with the use of speed limit parameter. Further calibration of ‘traffic flow speed’-‘traffic flow density’ curve (TFS/TFD curve) is based on free flow behavioral analysis with the consideration of GPS collected data on travel time distribution. Using the calibrated TFS/TFD curve and measured values of median vehicle travel time, calculation unit provides traffic flow estimation for each timing interval. GPS probe data is used as an indicator of the degree of road congestion for under-saturated conditions. For these conditions traffic flow estimations may be recalculated and refined with the use of GPS probes data.

The array of traffic volume estimated values together with the array of values of traffic flow speed for each segment/section of the road for each timing interval provides a full description of traffic flow patterns for the road network.

Presently invented automated system and for traffic volume estimation consists of:
1. Road information descriptor (RID);
2. Traffic signal descriptor (TSD);
3. GPS travel time collector (GTC);
4. GPS probes collector (GPC);
5. Computation analytical unit with novel algorithm for data processing, analyzing and calculation of traffic flow parameters (CAU).

RID performs the following sequence of operation for road information collection and description:
Assigning of controlled route, which comprises one or more sections. Each section represents a movement in a single direction between intersections;
For each controlled route, collecting information on segments coordinates. Note: segments are assigned by GPS provider, which may be in-house or third party;
Assign each segment to a particular section;
Obtaining road pattern information for each segment, including at least the following: number of lanes, lane width and grade, number of public transportation stops, area type and road class, types of turning movements, pedestrian-bike lanes, and speed limits. This list may also include other data, necessary for road capacity determination;
Obtaining same road pattern information for each route, crossing the controlled route. Forks or other kinds of junctions are also counted as crossings;
Collecting coordinates for traffic lights positions and assigning them to the intersections;
Submitting the information to CAU.

TSD performs the following sequence of operation for signal timing data collection and description:
Obtaining information about timing plans for traffic lights situated on controlled route, including phase description, data on all cycle elements and offsets for each timing plan assigned, timing plan schedule. This list may also include other data necessary for effective green time calculation for each section;
Submitting the information to CAU.

GTC performs the following sequence of operation for travel time data collection and description:
Continuously obtaining individual or aggregated travel time data for each segment for each available timing interval (usually scaled between 1 min and 1 h) from third party provider.
Performing preliminary processing of obtained data, excluding abnormal values and filtering outlier values using the ‘three sigma’ rule or other similar statistical method;
Generating, from obtained travel time data, the information on mean speed and speed distribution for each segment for each timing interval of each day of the week;
Storing and accumulating the produced information in a database which may be arranged on ‘day-of-week’ basis;
Submitting the information to CAU.

GPC continuously obtains individual or aggregated GPS probe data by recording each probe point or obtaining number of probes from third party provider for each available timing interval for each segment, stores and accumulates this information, like GTC does, and submits it to CAU. GPC may collect all kinds of information that describe a number of observed vehicles directly or indirectly, including complex parameters like “confidence factor” [12].

CAU describes a controlled route as one or several connected sections. Each section may consist of one or several segments. Last segment of each section may have a substantial change in driving conditions on its end, e.g. traffic light, crossing, public transport stop, or others. Then, CAU employs the novel algorithm to estimate traffic flow. The main principles of the novel algorithm are as follows:
Traffic flow volume is estimated for the section—not for a segment or for a controlled route;
Road patterns, signal timing, GPS travel times and GPS probes are used simultaneously for better calibration of fundamental diagram or “speed/density curve”;
Free flow speed may be calculated with the consideration of travel time distribution over non-saturated conditions;
GPS probes are used for refining the traffic volume estimation for under-saturated conditions, as well as for balancing the traffic flow estimation values in road network nodes.

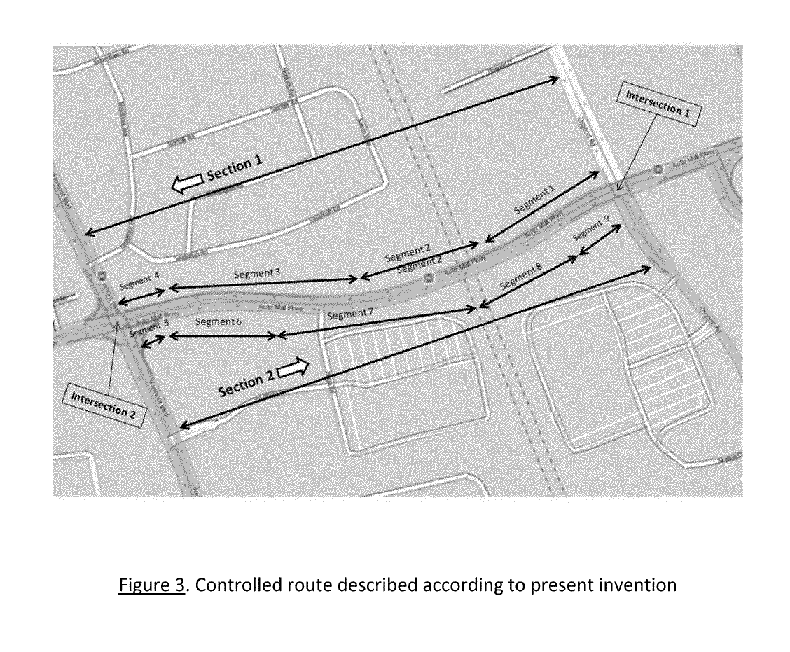

According to the said principles, CAU performs the following sequence of operation for traffic flow volume estimation for each section:
Assigning the lane utilization factor, heavy vehicles adjustment factor, frequency of parking maneuvers, base saturation flow, pedestrian/bike influence on turns with the consideration of area types and road classes;
Calculating the factor values for the influence of crossings;
Calculating the factor values for influence of the effective green time on road capacity for each timing interval. Effective green time may be estimated without knowledge on signal timing, based on the traffic light regime assumption. Such an assumption may be made with the use of standard signal timing development procedure and the information collected by RID and any standard software for signal timing optimization and development (for example, Transyt-7F or Synchro). Obviously, accurate assumption ensures traffic volume estimation accuracy increase;
Calculating the value of saturation flow for all included segments, and assigning a critical segment characterized by the minimal value of saturation flow. If one or more segments with substantially lower value of saturation flow are found somewhere within the section, then the section may be correspondingly subdivided, with the assignment of one critical segment per each new section;
Determining the free flow period of time for each day of the week. Free flow period may be characterized by lower values of GPS probes (usually less than 10-20% from registered maximum for the day) and higher values of median speed (usually more than 60-80% of registered maximum for the day). As an additional sign of free flow period, statistical attributes of speed distribution are used (for example the magnitude between 10% speed and 90% speed);
Calculating the free-flow speed for each section as a maximal speed for free flow period, averaged by all segments included in the section. Free flow speed may also be assigned a value of the registered speed limit or a maximal speed for free flow period determined for a critical segment; this approach, though, leads to a lower accuracy;
Assigning a value of saturation flow calculated for the critical segment as a value of saturation flow for the section;
Using the data gathered and calculated above, determining critical density and calibrating speed-density curve for the section;
Estimating the flow volume for each timing interval. This operation may use the standard equations described in [9], or other mathematical description of speed-density curve (traffic fundamental diagram), including but not limited to asymmetrical one (see, for example, FIG. 3 from [5]);
Further refining of the traffic flow volume estimation for semi-saturated zone where speed is between V₁ and V₂ and probe value is between R₁ and R₂ (usually V₁ is expected between 40% and 50%; V₂ between 50% and 65% of median speed, and R₁ is expected between 50% and 65%; R₂ between 60% and 75% of maximal probe during the day). Said values may further vary depending on the road network specifics. For semi-saturated zone, the flow volume (F_{ssz}) for a timing interval “i” may be estimated as:

F_{ssz(i)}=Fₘₐₓ×(Rᵢ/Rₘₐₓ)^{∝},

where Rᵢ represents probe value for “i” timing interval, α—power factor;
Further refining of the traffic flow volume estimation for non-saturated zone, where speed is above V₃ and probe value is between R₃ and R₄ (usually V₃ is expected to be more than 70% of median speed, and R₃ is expected to be less than 20% of maximal probe during the day). Said levels may vary depending on road network specifics. For non-saturated zone, the flow volume (F_{nsz}) for a timing interval “i” may be estimated as:

F_{nsz(i)}=Fₘₐₓ×(Rᵢ/Rₘₐₓ)^{β},

where Rₘₐₓ is maximal value of GPS probe for the day, β—power factor;

Further refining of the traffic flow volume estimation for a section with poor GPS data, using historic information available from GPS data provider for several weeks and further accumulated by GTC and GPS. Historic information may be grouped for same days of week, and further processed as described above;
Further refining of the traffic flow volume estimation for sections with extremely poor GPS data, which usually a case for low-class (secondary and below) roads with non-saturated traffic conditions, as well as for developing countries. In addition to the use of historic information for probe size determination (Rᵢₕ), the estimation based on adjourning roads GPS probes may be used. Flow volume (Fₑₚ) for timing interval “i” may be estimated as:

Fₑₚ₍ᵢ₎=F_{adr}×γ×(Rᵢₕ/Rₘₐₓ)^{ε},

where γ is a ratio for calculated value of saturation flows for the section and adjourning road, F_{adr}—estimated flow for adjourning road, ε—power factor;
Further refining of the traffic flow volume estimation with the consideration of registered events, which may change the road conditions, such as incidents, repairs, etc. This information, gathered form GPS provider, is used for further calibration of TFS/TFD curve and calculation of saturation flow value for segments and, correspondingly, sections. Appearance or disappearance of critical segment may cause the need to redivided a section based on this information.

### EXAMPLE

The example below illustrates the use of the invention for traffic survey for westbound control route at intersection # 134 (code: AUMAp/FRMTb).

The description of controlled route (Section 1, FIG. 3) was done using open source GIS system. Signal timing information had been requested from town transportation authorities. GPS data was obtained from navigation provider, which has a presence on global market.

There are a number of segments assigned by navigation provider for this controlled route. Segments have from 2 to 5 lanes. CAU described the controlled route by one section between two intersections.

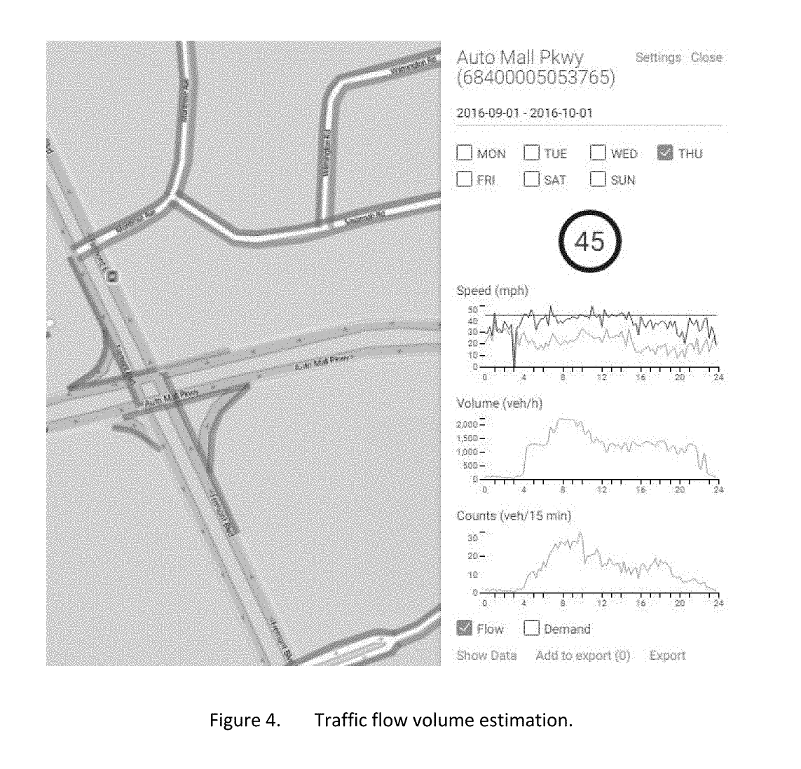

Traffic flow volume estimation made by presently invented automated system with the use of integrated method described above shown on the FIG. 4.

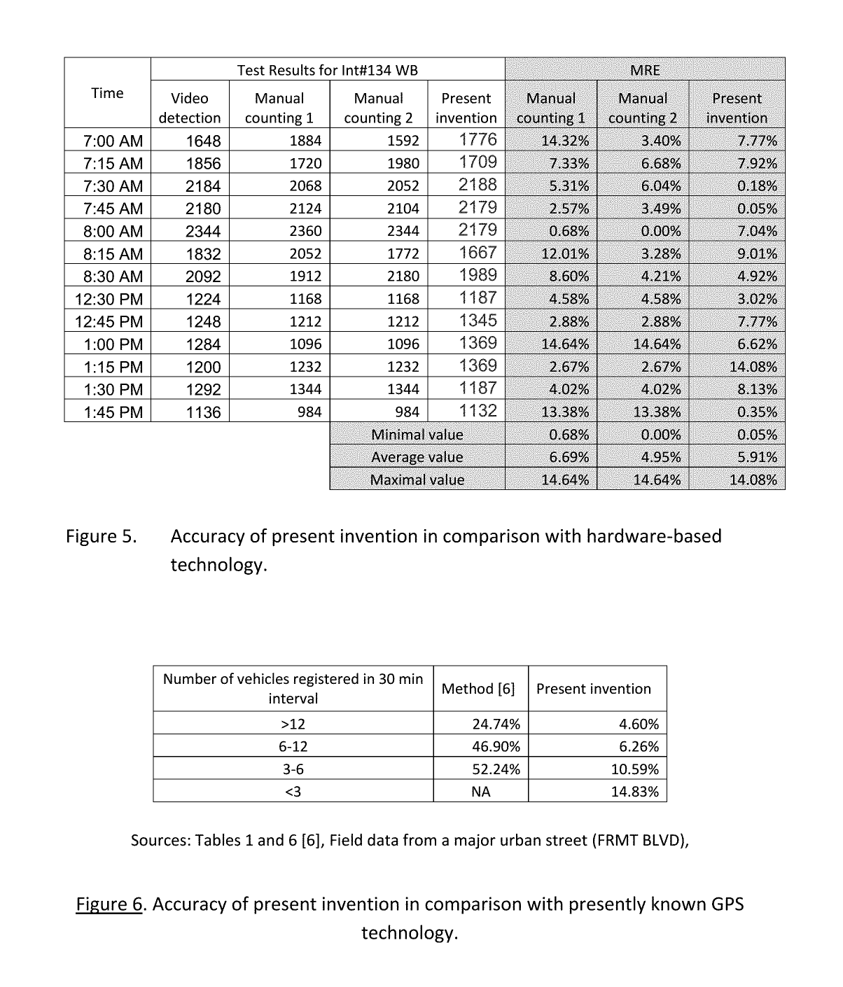

Estimation results had been verified by state-of-the-art video detection system, widely recognized by transportation community as trusted source of information [1, 2]. Additionally, manual counting had been performed. FIG. 5 illustrates high accuracy of present invention. It is visible from the table, that median relative error (MRE) for presently invented method and system at least not worse that for video detection. Of course, it is incomparable with presently known GPS-based methods (FIG. 6). Needless to say, that, being hardware free, presently invented system and method are significantly more efficient that presently known technologies.

### REFERENCES

1. E. Minge et al. Evaluation of non-intrusive technologies for traffic detection, MN DOT, 1020.

2. G. Leduc. Road Traffic Data: Collection Methods and Applications. European Commission Joint Research Centre, Institute for Prospective Technological Studies, 2008.

3. U.S. Pat. No. 9,053,632 B2 from Jun. 9, 2015. Real-time traffic prediction and/or estimation using GPS data with low sampling rates.

4. U.S. Pat. No. 8,150,611 B2 from Apr. 3, 2012. System and methods for providing predictive traffic information.

5. Patent US20150120174 A1 Apr. 30, 2015. Traffic volume estimation.

6. X. Zhan et al. Citywide traffic Volume Estimation Using Trajectory Data, IEEE Transactions of Knowledge and Data Engineering, October 2016.

7. J. C. Herrera. Assessment of GPS-enabled smartphone data and its use in traffic state estimation for highways. University of Berkeley, 2009.

8. B. Cameron. Evaluation of Signal Retiming Measures Using Bluetooth Travel Time Data. A thesis presented to the University of Waterloo in fulfillment of the thesis requirement for the degree of Master of Applied Science in Civil Engineering. Waterloo, Ontario, Canada, 2015.

9. N. J. Garber, L. A. Noel. Traffic and Highway Engineering. Second edition, PWS Publishing Co, NY, 1110 p. 2012.

10. G. Brodski et al. Quantitate analysis of traffic flows in the city of Moscow. Roads world, #26, p. 2-5, 2007

11. J. Gerken et al. Accuracy Comparison of Non-Intrusive, Automated Traffic Volume Counting Equipment. AG, Inc., 2009.

12. HERE. Tips & Tricks. Understanding of customer integration testing environment. HERE.com, 2017

1. An automated system comprising road information descriptor, traffic signal descriptor, GPS travel time collector, GPS probes collector, and computation analytical unit with novel algorithm for data processing and estimation of traffic flow volume, wherein all constituents employed for combined operation.

2. An integrated method for estimation of traffic volume for a section of the road, such section representing a movement in a single direction between intersections, comprising:
a. obtaining geo coordinates and travel direction information about road segments situated on a section as described by available source of GPS data;
b. obtaining road geometry information for each segment included in a section, including widths, slopes, and number of lanes;
c. obtaining all available traffic-related information that characterizes the parameters influencing the road capacity, including traffic signs, speed limits, public transport stops, and more for a section;
d. obtaining the same information about all roads, which cross or converge with said section;
e. obtaining the information about traffic lights, which may be located throughout a section, including signal timing data;
f. collecting raw or pre-processed travel time information for each segment from available sources of GPS data, including median travel time, travel time distribution and other speed related information that may be available;
g. collecting raw or pre-processed information about the number of observed vehicles (GPS probes) for each segment from available source of GPS data, and other probe-related information that may be obtainable;
h. collecting raw or pre-processed information about changes in traffic situation for each segment from available source of GPS data, including incidents, repairs, and other road capacity related information that may be available;
i. accumulating all data collected from GPS source; data may be arranged by days of week;
j. determining free flow time periods for each day of the week, where any such free flow period may be characterized by lower values of GPS probes, higher values of median speed, and high differential between the highest and lowest registered speed, with filtered-out values being excluded;
k. calculating the free-flow speed for each section and for each day, based on the processed travel time for free-flow period, averaged by all segments included in the section;
l. calculating the value of saturation flow for each segment in a section based on obtained road geometry data, other traffic-related road information and calculated effective green time;
m. assigning a critical segment as a segment with the smallest saturation flow value, and determining a saturation flow for the section as equal to the one for a critical segment;
n. calibrating speed-density curve using calculated values of saturation flow and free-flow speed for a section;
o. estimating the traffic flow volume for each timing interval for each section, using said calibrated speed-density curve and accumulated collected information on travel time and traffic situation;

3. A method of claim 2, wherein free flow speed value is being determined as a value of speed limit;

4. A method of claim 2, wherein free flow speed value is being determined as a value of free flow speed defined for critical segment;

5. A method of claim 2, wherein the flow volume is estimated with the use of collected GPS travel time, traffic situation and probe data related to current timing interval as well as all available historic travel time and probe GPS data related to same timing interval of the week;

6. A method of claim 2, wherein the traffic flow volume estimation may be refined:
a. for observed periods with non-saturated traffic conditions by estimating based on current value of GPS probes relatively to maximal registered probe value for the day;
b. for sections with extremely poor GPS data by estimating based on current value of GPS probes relatively to probe value for the same timing interval registered on adjourning roads with better GPS data, with simultaneous consideration of saturation flow values differences for said roads;

7. A method of claim 2, wherein the traffic flow volume estimations for several intersecting sections may be refined by balancing of the values of GPS probes registered for all sections for the same timing interval.

8. A method of claim 2, wherein the assignment of sections may be dynamically changed based on the observance of registered events which may substantially change the saturation flow values for one or more segments within the section.
